(19) United States
(12) Patent Application Publication
(10) Pub. No.: US 2002/0081147 A1
(43) Pub. Date: Jun. 27, 2002

(54) Composite steering shaft with u-jointless tiltsteer joint

(76) Inventors: Nicholas James Gianaris, West Bloomfield, MI (US); Atiya M. Ahmad, Southfield, MI (US)

Correspondence Address: Steven W. Hays, Suite 250, 28333 Telegraph Road, Southfield, MI, 48034, US

(21) Appl. No.: 10/022,883

(22) Filed: Dec. 18, 2001

Related U.S. Application Data
(60) Provisional application No. 60/257,625, filed on Dec. 21, 2000.

(51) Int. Cl. F16B 1/00; F16D 1/00

(52) U.S. Cl. 403/223

(57) ABSTRACT

A composite steering shaft that replaces traditional metal steering shafts in a steering system. The composite steering shaft is made of layers of braided fiber contained within a polymer matrix resin. Stiffness and torsional strength within the non-tilting and tilting regions may be controlled as a function of the number of layers of braided fiber, the orientation of fiber within those layers, and the type and amount of curing of the polymer matrix resin. The composite shaft may be a one-piece shaft having a compliant middle region and a stiff upper and lower portion or may be a two-piece shaft coupled together using an I-protec metal joint.

### CROSS-REFERENCE TO RELATED APPLICATIONS

This application claims priority to provisional application Serial No. 60/257,625, filed Dec. 21, 2000.

### TECHNICAL FIELD

The present invention relates generally to steering columns and more particularly to composite steering shafts and with a u-jointless tiltsteer joint.

### BACKGROUND

Steering column support housings are assemblies used to house and support the various subassemblies used to control and steer a vehicle. A support housing typically contains one or more of a steering column, a steering shaft, a tilt head, a telescoping mechanism, a key ignition, an interlock mechanism a wiring harness, and a column shift mechanism. The primary functions of a support housing are to: (1) support the steering column in a vehicle; (2) support the tilt and/or telescoping features of a steering column; and (3) provide for energy absorption in a crash. Support housings also provide, among other things, a place to mount a wiring harness, support column shift mechanisms, support interlock mechanisms, and support key ignitions.

Presently available support housing designs typically utilize a cast metal housing that is attached with brackets to a vehicle's instrument panel and/or cross car beam. Depending upon the type of steering column (rake, tilt, or telescoping) and the crash energy management scheme (breakaway or internal collapse) utilized, the attachment method of the steering column support housing to the vehicle structure varies greatly. For optimum performance, support housings are designed to meet weight, NVH (noise, vibration and harshness), and crash energy management targets required of a steering column assembly.

Design trends with steering column support housings are very similar to other vehicle design features. Lighter, stronger, more easily constructed materials are being investigated to enhance current steering column support designs and to improve component features. This can lead to stronger, safer vehicles that can also meet fuel economy targets.

While a great deal of work has been applied to improving steering column support housings, little if any work has been done to improve the steering shaft itself, despite the fact that similar technologies can be investigated in order to incorporate lighter, stronger, more easily constructed materials into the steering shaft. As such, steering shafts are typically still made today of cold rolled steel or a similar metal and typically have a high precision bearing system at the tilt U-joint. These steering shafts, typically experience problems with NVH, lash, and torsional rigidity due to the number of pieces involved in making the steering shaft. This also adds cost in terms of manufacturing and assembly. Finally, the steering shafts are heavy and contribute to costs associated with fuel economy and other environmental concerns.

It is thus desirable to incorporate the composite technologies described above into the steering shaft itself to improve crash energy management and NVH characteristics. Summary Of The Invention

It is thus an object of the present invention to incorporate fiber reinforced composite technologies into the steering shaft to give a steering shaft having improved crash energy management and NVH characteristics.

In one preferred embodiment of the present invention, the steering shaft is made of a fiber reinforced composite material and has an integral tilt portion.

In another preferred embodiment of the present invention, the steering shaft is composed of two fiber reinforced composite pieces that are coupled together using a metal joint.

In another preferred embodiment of the present invention, the steering shaft is made of a fiber reinforced composite material having a rubbery type composite shaft used for tilting.

In addition, all of the preferred embodiments described above may be incorporated into a composite steering shaft to further decrease weight, increase strength, decrease NVH, and improve crash energy management.

The steering column shafts described above are formed by one of many composite manufacturing processing. This includes but is not limited to compression molding, injection molding, and bladder molding.

Other objects and advantages of the present invention will become apparent upon considering the following detailed description and appended claims, and upon reference to the accompanying drawings.

### BRIEF DESCRIPTION OF THE DRAWINGS

FIG. 1 shows a steering assembly having a one piece composite joint according to one embodiment of the present invention;

FIG. 2 shows a one piece composite joint of FIG. 1 according to one preferred embodiment of the present invention;

FIG. 3 shows a close-up sectional view of the accordion region of FIG. 2;

FIG. 4 illustrates the fiber orientation within one layer of braided fiber of FIG. 3;

FIG. 5A illustrates a one-piece composite steering shaft according to another preferred embodiment of the present invention;

FIG. 5B illustrates the fiber orientation within one layer of braided fiber within the rubbery-like accordion region of FIG. 5A;

FIG. 5C illustrates the fiber orientation within one layer of braided fiber within the upper and lower portion of FIG. 5A;

FIG. 6A illustrates a one-piece composite steering shaft according to another preferred embodiment of the present invention;

FIG. 6B illustrates the fiber orientation within one layer of braided fiber within the rubbery-like middle region of FIG. 6A;

FIG. 6C illustrates the fiber orientation within one layer of braided fiber within the upper and lower portion of FIG. 6A;

FIG. 7 illustrates an exploded view of a two-piece composite shaft and I-protec metal joint according to another preferred embodiment of the present invention;

FIG. 8 shows the two-piece composite shaft of FIG. 7 coupled within the I-protec metal joint;

FIG. 9 illustrates a sectional view of FIG. 8 taken along line 9-9;

FIG. 10A illustrates an alternative arrangement of FIGS. 1-9 that adds a crush initiation feature according to one preferred embodiment of the present invention;

FIG. 10B is a sectional view of FIG. 10A taken along line 10B-10B;

FIG. 11 illustrates another alternative arrangement of FIGS. 1-9 that adds a crush initiation feature according to another preferred embodiment of the present invention; and

FIG. 12 illustrates an alternative arrangement of FIGS. 1-9 that adds a crush initiation feature according to another preferred embodiment of the present invention.

### DESCRIPTION OF THE PREFERRED EMBODIMENT(S)

In the following figures, the same reference numerals will be used to identify identical components in the various views. The present invention is illustrated with respect to a steering system, particularly suited for the automotive field. However, the present invention is applicable to various other uses that may require steering systems.

FIGS. 1-3 illustrates a steering assembly 13 according to one preferred embodiment of the present invention.

As shown in FIG. 1, a one-piece composite steering shaft 15 is coupled at its lower end to a rack and pinion assembly 14 and is coupled at its upper end to a driver interface, here a steering wheel 16. Of course, other driver interfaces such as steer by wire may be used as is known in the art. A steering column support assembly 18 surrounds an upper portion of the composite steering shaft 20 and has brackets 22 used to secure the support assembly 18 to the instrument panel or firewall in a method that is well known in the art.

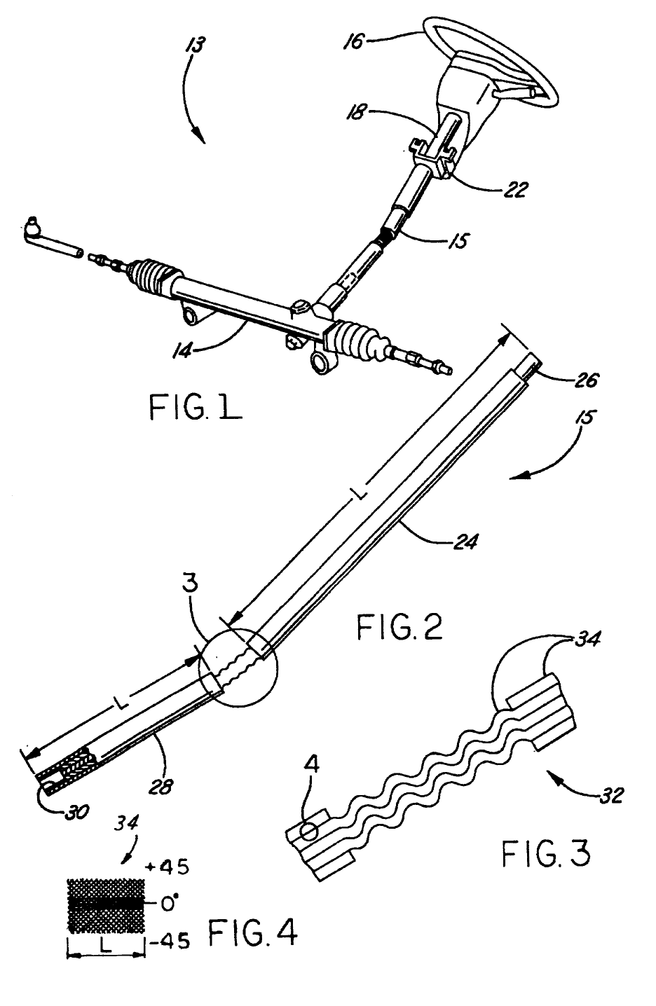

As best seen in FIG. 2, the upper portion 24 of the composite steering shaft 15 preferably has a male spline section 26 that couples into a corresponding female spline section (not shown) of the steering wheel 16. Of course, other methods not shown are contemplated to secure the upper portion 24 of the composite steering shaft 15 to the steering wheel. For example the upper section could consist of an upper shoulder that snap fits into a corresponding female portion of the steering wheel. Alternatively, this top shoulder could be otherwise clamped or bolted into the corresponding female section.

Similarly, the lower portion 28 of the one-piece composite shaft 15 has an internal splined portion 30 that couples to a corresponding splined portion of an intermediate shaft (not shown) of the rack and pinion assembly 14. Of course, similar to the upper portion 24, the lower portion 28 may be otherwise coupled to the rack and pinion assembly 14 in a variety of other methods that are well known in the art.

As best seen in FIG. 3, the one-piece composite shaft 15 also has an accordion-like tilt portion 32 between the upper portion 24 and the lower portion 28 that accommodates a tilt feature desired in present day steering systems 13.

The upper portion 24, the accordion-like tilt portion 32, and the lower portion 28 are comprised of a composite material consisting of strands of fibers 34 braided and layered within a matrix material. The composite material having braided fibers 34 is highly efficient in distributing loads, has excellent impact resistance (i.e. absorbs a lot of energy), has excellent fatigue resistance, and is a highly efficient reinforcement material for torsional loading.

The fibers 34 used are preferably carbon, glass, or aramid fibers. However, other types of fibers 34 may be used that are contemplated in the art. For example, graphite fibers may be used. The matrix material that is used includes moldable thermosetting or thermoplastic polymers, metal, ceramic, or any other material that exhibit good strength and processability and meet recyclable regulatory demands. One preferred matrix material is a recyclable thermoplastic epoxy. The replacement of metal with composite materials with some of the above matrix materials decreases the weight of the steering shafts 15. This results in better fuel economy in addition to other improved vehicle performance characteristics.

The one-piece composite steering shaft 15 may be fabricated in a wide variety of process including but not limited to autoclave, resin transfer molding (“RTM”), vacuum assisted resin transfer molding (“VATRM”), pultrusion, compression molding, bladder molding and injection molding.

One important consideration is type of fiber 34 that is braided and layered within the matrix material. For instance, if stiffness is a critical property for NVH or lash in specific loading directions, then high modulus fiber such as carbon or graphite is preferred. If strength is more important, then carbon or glass fibers are preferred. If toughness is critical, then aramid fiber alone or in combination with another kind of fiber 34 is preferred. Importantly, by combining different types of fiber 34 within the braid or within the layers, a combination of these properties may be achieved.

Another important consideration in the steering shaft 15 is the number of braided fiber 34 layers contained within the matrix material. As the number of layers of braided fiber 34 increases, performance characteristics generally improve. However, as the amount of matrix material and braided fiber 34 layers, and correspondingly the weight of the one-piece composite steering shaft 15 correspondingly increases, the cost effectiveness in terms of manufacturing costs, raw material costs, and fuel economy correspondingly decreases.

Another important consideration in the steering shaft is the orientation of the braided fibers 34 within a given layer. Fibers oriented in a [+/−45] degree arrangement relative to the length of the shaft 15 tend to give higher stiffness and torsional strength, especially when combined with fibers oriented 0 degrees (axially) to the shaft 15 length l, which improve toughness and impact resistance. Fibers oriented at more obtuse angles such as [+/−60] degrees or [+/−75] degrees tend to give high torsional strength and high toughness.

Preferably, as best seen in FIG. 4, the fiber 34 orientation within each layer of the upper portion 24, accordion region 32, and lower portion 28 is oriented in a [+/−45, 0] degrees arrangement relative to the length l of the shaft 15 utilizing glass fibers. A fully cured thermosetting epoxy resin is used in the upper portion 24 and lower portion 28 to impart high stiffness and high tensile strength to the regions. A partially cured thermosetting epoxy resin or elastomeric resin such as polyurethane is used in the accordion region 32 to impart high torsion resistance and high compliance.

Further, approximately 2-5 layers of continuous braided fibers 34 are stacked on top of each other within the matrix material and molded to form the steering shaft 15. The accordion-like tilt region 32 is formed from at least one less layer of braided fibers 34 than the upper portion 24 and lower portion 28, but shares most the same common continuous braided fiber 34 layers. This, along with the use of the elastomeric polyurethane resin or partially cured epoxy resin, allows the accordion-like region 32 more flexibility, thereby allowing the region 32 to tilt or telescope more easily.

FIGS. 5A-C and 6A-C describe two more preferred embodiments of the present invention, in which the number of layers of continuous braided fiber 34 layers is consistent throughout the steering shaft 15.

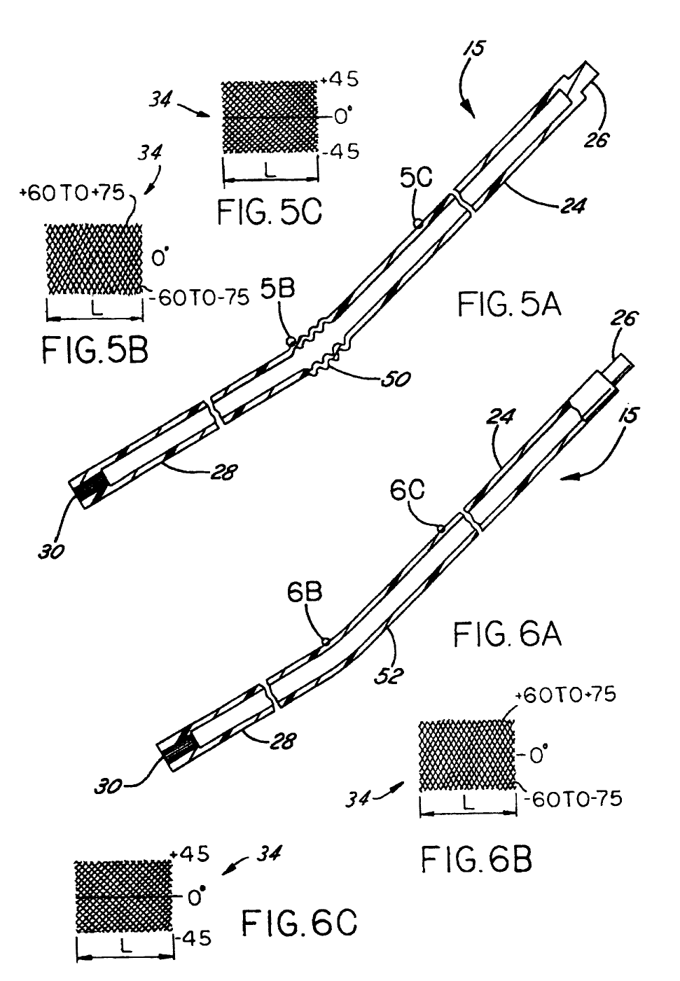

As shown in FIG. 5A, the accordion tilt region 32 of FIGS. 1-4 is replaced with a rubbery-like accordion region 50. The rubbery-like accordion region 50 contains the same number of braided fiber 34 layers as the upper portion 24 and lower portion 28. However, as shown in FIG. 5B, the fiber 34 orientation within the rubbery-like accordion region 50 -is preferably between approximately [+/−60] to [+/−75] degrees. While not shown, fibers 34 oriented at 0 degrees relative to the shaft length l may be added to improve toughness and crash resitance. As shown in FIG. 6C, the fiber orientation within the upper portion 24 and lower portion 28 is [+/−45, 0] degrees relative to the length l of the steering shaft 15. The resin composition of the upper and lower portions 24, 28 is preferably a thermosetting epoxy resin as described in FIGS. 1-4, while the resin composition of the rubbery-like tilt region 50 is preferably the polyurethane elastomeric resin or partially cured epoxy resin as described in FIGS. 1-4.

As shown in FIG. 6A, the rubbery-like accordion region 50 is replaced with a rubbery-like middle region 52 not having an accordion-like structure like in FIG. 5A. The rubbery-like middle region 50 contains the same number of braided fiber 34 layers as the upper portion 24 and lower portion 28. However, as shown in FIG. 6B, the fiber 34 orientation within the rubbery-like middle region 52 is preferably between approximately [+/−60] to [+/−75] degrees relative to the length l of the shaft. While not shown, fibers 34 oriented at 0 degrees relative to the shaft length l may be added to improve toughness and crash resitance. As above, as shown in FIG. 6C, the fiber 34 orientation within the upper portion 24 and lower portion 28 is [+/−45, 0] relative to the length l of the steering shaft 15. The resin composition of the upper and lower portions 24, 28 is preferably a thermosetting epoxy resin, while the resin composition of the rubbery-like middle region 52 is preferably the polyurethane elastomeric resin or partially cured epoxy resin as described above with respect to FIGS. 1-4.

Thus, in the embodiments of FIGS. 5A and 6A, a composite steering shaft 15 having a high torsion and high stiffness upper portion 24 and lower portion 28 and a high torsion and high compliance tilt region 50, 52 is achieved. A bladder molding system is preferably used to form the composite shafts 15 of FIGS. 5 and 6. In this process, the braided fiber layers 34 are formed and placed inside a mold. A bladder is introduced within the middle of the mold to push the braided fiber 34 layers towards the outside of the mold. The resin composition for upper portion 24, lower portion 28, and rubbery-like region 50, 52 is introduced and the part is placed into an oven for curing. The bladder is then removed from the center of the steering shaft 15 and the shaft 15 is cooled.

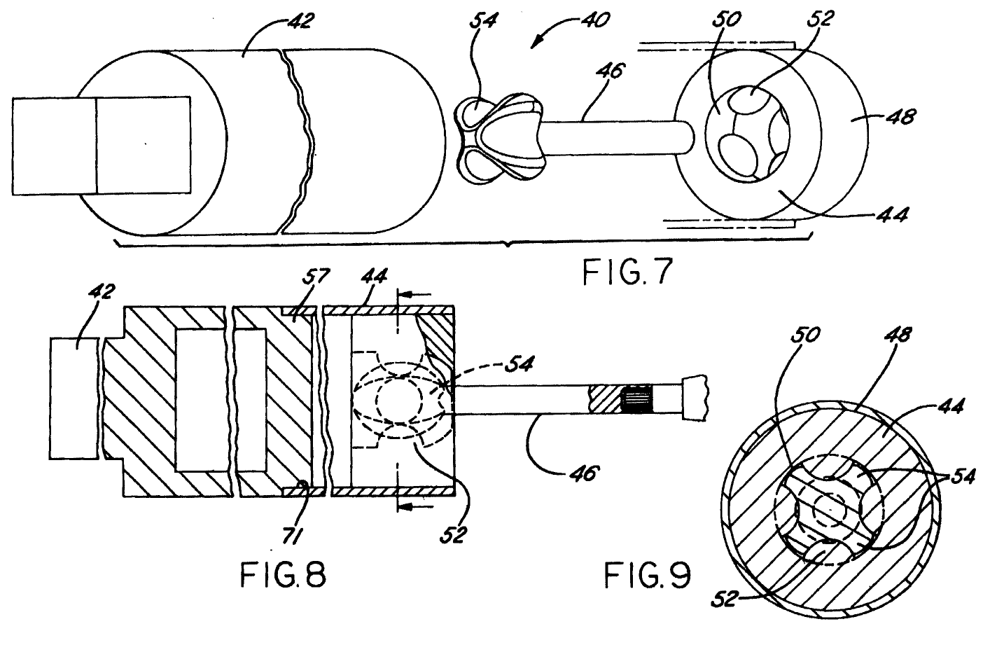

In another embodiment, as shown in FIGS. 7-9, a steering shaft 40 is formed from an upper composite shaft 42 and a lower composite shaft 46 coupled together using an I-protec metal joint 44. The steering shaft 40 may be used in a steering system 13 such as that shown in FIG. 1.

The composite material used in the upper composite shaft 42 and lower composite shaft 46 is a similar material used in the upper portion 24 and the lower portion 28 of FIG. 1. It preferably contains 2-5 layers of braided glass fibers (not shown) oriented at [+/−45, 0] degrees and utilizing a thermosetting epoxy resin.

Referring to FIG. 9, the I-protec metal joint 44 is shown as having a substantially annular shaped outer region 48 and a substantially annular shaped inner region 50. The inner region 50 has a plurality of raised semispheroidal members 52 that engage a corresponding race 54 located at the end of the lower composite shaft 46. The race 54 may be metal or may be formed from a thermosetting epoxy material as described above in FIGS. 1-7. Further, a lower shoulder 57 of the upper composite shaft 42 is press fit into a within a corresponding portion 71 of the I-protec joint 44.

Of course, in alternative preferred arrangements, the upper composite shaft 42 could have a race that couples to the raised semispheroidal members 52 of the I-protec joint 44 and the lower composite shaft 46 could be press fit into a portion of the I-protec joint and still fall within the spirit of the present invention.

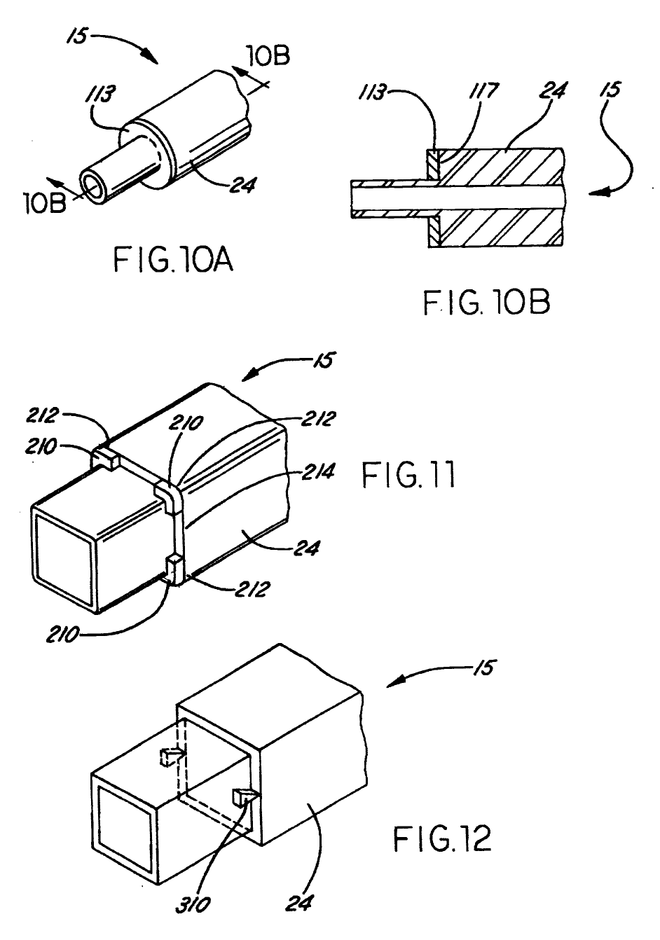

FIGS. 10A, 10B, 11 and 12 below describe modifications that may be made to the steering shafts of FIGS. 1-9 that are used to cause the steering shafts 15, 40 to crush upon themselves during crash situations.

In one alternative arrangement, as shown in FIG. 10A and 10B, the shape of the upper portion 24 of the steering shaft 15 is substantially round and a tapped insert 113 is coupled to the topmost portion 117 of the upper portion 24. This tapped insert 113, along with a crush initiation region located in close proximity to the tapped insert 113, are designed to cause the shaft 15 to crush upon itself to absorb energy during crash situations.

In another alternative arrangement, as shown in FIG. 11, the shape of the upper portion 24 of the composite shaft 15 is substantially squared and a plurality of metal plugs 210 can be added to each of the corners 212 at the topmost portion 214 of the upper portion 24 of the shaft 15. In a crash situation, the metal plugs 210 push backwards and down the shafts 15 causing the shafts 15 to crush in a flowering pattern to absorb energy.

In yet another embodiment, as shown in FIG. 12, a shift cane 310 or similar protruding object may be added to one of the outer layers 314 of the upper portion 24 of the steering shaft 15. The shift cane 310 will initiate shearing, or peeling, of the outer layers of the upper portion 24 of the shaft 15 in crash situations.

The steering shaft 15, 40 as shown in FIGS. 1-12 is typically placed within a steering column support housing is well known in the art. Presently available support housing designs typically utilize a cast metal housing that is attached with brackets to a vehicle's instrument panel and/or cross car beam. Depending upon the type of steering column (rake, tilt, or telescoping) and the crash energy management scheme (breakaway or internal collapse) utilized, the attachment method of the steering column support housing to the vehicle structure varies greatly. For optimum performance, support housings are designed to meet weight, NVH (noise vibration and harshness), and crash energy management targets required of a steering column assembly.

Alternatively, as described in U.S. patent application Ser. No. 09/951,313 to Gianaris et. al, filed Sep. 13, 2001, which is herein incorporated by reference, the cast metal housing can be replaced with composite support column to house the composite shaft 15, 40. This composite column, in conjunction with the composite steering shafts 15, 40, further decreases the weight to further improve such things as fuel economy.

While the invention has been described in terms of preferred embodiments, it will be understood, of course, that the invention is not limited thereto since modifications may be made by those skilled in the art, particularly in light of the foregoing teachings.

What is claimed is:

1. A lightweight steering shaft comprising:
a composite upper portion having n layers of a braided fiber having a first fiber orientation within a thermosetting polymer matrix resin;
a middle portion capable of tilting; and
a composite bottom portion having n layers of said braided fiber within said thermosetting polymer matrix resin.

2. The steering shaft of claim 1, wherein n is an integer and is between approximately 2 and 5.

3. The steering shaft of claim 1, wherein said first fiber orientation is an approximately [+/−45, 0] degree fiber orientation relative to the length of the steering shaft.

4. The steering shaft of claim 1, wherein said middle portion comprises an accordion like middle portion comprising n−1 layers of said braided fiber contained within said thermosetting polymer matrix resin.

5. The steering shaft of claim 1, wherein said thermosetting polymer matrix resin comprises a fully cured thermosetting epoxy matrix resin.

6. The steering shaft of claim 1, wherein said middle portion comprises an a rubbery like accordion region having n layers of said braided fibers at a first fiber orientation contained with a flexible polymer matrix resin, wherein said first fiber orientation is between approximately [+/−60] degrees and [+/−75] relative to the length of the steering shaft, and wherein said flexible polymer matrix resin is selected from the group consisting of a partially cured thermosetting epoxy matrix resin and a elastomeric polyurethane matrix resin.

7. The steering shaft of claim 1, wherein said middle portion comprises an I-protec metal joint.

8. The steering shaft of claim 1 further comprising a plurality of metal plugs coupled on a shoulder portion of said upper portion.

9. The steering shaft of claim 1 further comprising a tapped insert coupled to a shoulder portion of said upper portion.

10. The steering shaft of claim 1 further comprising a shift cane coupled to at least an outermost of said n layers of said braided fibers.

11. A method for reducing weight in a steering system capable of tilting comprising:
providing a one-piece fiber reinforced composite steering system having a composite upper portion having n layers of a braided fiber having a first fiber orientation within a thermosetting polymer matrix resin, a middle portion capable of tilting, and a composite bottom portion having n layers of said braided fiber within said thermosetting polymer matrix resin;
coupling said upper portion to a steering wheel and a rack and pinion system; and
coupling said bottom portion to a rack and pinion system.

12. The method of claim 11, wherein providing a one-piece fiber reinforced composite steering shaft comprises providing a one-piece fiber reinforced composite steering system having a composite upper portion having n layers of a braided fiber having a first fiber orientation within a thermosetting polymer matrix resin, a middle portion capable of tilting, and a composite bottom portion having n layers of said braided fiber within said thermosetting polymer matrix resin, wherein n is an integer and is between approximately 2 and 5.

13. The method of claim 11, wherein providing a one-piece fiber reinforced composite steering shaft comprises providing a one-piece fiber reinforced composite steering system having a composite upper portion having n layers of a braided fiber having a first fiber orientation within a thermosetting polymer matrix resin, a middle portion capable of tilting, and a composite bottom portion having n layers of said braided fiber within said thermosetting polymer matrix resin, wherein said first fiber orientation is a approximately [+/−45, 0] degree fiber orientation relative to the length of the steering shaft.

14. The method of claim 11, wherein providing a one-piece fiber reinforced composite steering shaft comprises providing a one-piece fiber reinforced composite steering system having a composite upper portion having n layers of a braided fiber having a first fiber orientation within a thermosetting polymer matrix resin, a middle portion capable of tilting, and a composite bottom portion having n layers of said braided fiber within said thermosetting polymer matrix resin, wherein said middle portion comprises an accordion like middle portion comprising n−1 layers of said braided fiber contained within said thermosetting polymer matrix resin.

15. The method of claim 14, wherein providing a one-piece fiber reinforced composite steering shaft comprises bladder molding a one-piece fiber reinforced composite steering system having a composite upper portion having n layers of a braided fiber having a first fiber orientation within a thermosetting polymer matrix resin, a middle portion capable of tilting, and a composite bottom portion having n layers of said braided fiber within said thermosetting polymer matrix resin, wherein said middle portion comprises an accordion like middle portion comprising n−1 layers of said braided fiber contained within said thermosetting polymer matrix resin

16. The method of claim 11, wherein providing a one-piece fiber reinforced composite steering shaft comprises providing a one-piece fiber reinforced composite steering system having a composite upper portion having n layers of a braided fiber having a first fiber orientation within a thermosetting polymer matrix resin, a middle portion capable of tilting, and a composite bottom portion having n layers of said braided fiber within said thermosetting polymer matrix resin, wherein said middle portion comprises an a rubbery like accordion region having n layers of said braided fibers at a first fiber orientation contained with a flexible polymer matrix resin, wherein said first fiber orientation is between approximately [+/−60] degrees and [+/−75] relative to the length of the steering shaft, and wherein said flexible polymer matrix resin is selected from the group consisting of a partially cured thermosetting epoxy matrix resin and a elastomeric polyurethane matrix resin.

17. The method of claim 16, wherein providing a one-piece fiber reinforced composite steering shaft comprises bladder molding a one-piece fiber reinforced composite steering system having a composite upper portion having n layers of a braided fiber having a first fiber orientation within a thermosetting polymer matrix resin, a middle portion capable of tilting, and a composite bottom portion having n layers of said braided fiber within said thermosetting polymer matrix resin, wherein said middle portion comprises an a rubbery like accordion region having n layers of said braided fibers at a first fiber orientation contained with a flexible polymer matrix resin, wherein said first fiber orientation is between approximately [+/−60] degrees and [+/−75] relative to the length of the steering shaft, and wherein said flexible polymer matrix resin is selected from the group consisting of a partially cured thermosetting epoxy matrix resin and a elastomeric polyurethane matrix resin.

18. A method for reducing weight in a steering system capable of tilting comprising:
providing a fiber reinforced composite upper portion having n layers of a braided fiber having an approximately [+/−45, 0] degree fiber orientation within a thermosetting polymer matrix resin;
providing a fiber reinforced composite bottom portion having n layers of said braided fiber within said thermosetting polymer matrix resin, wherein n is an integer and is between approximately 2 and 5;
providing an I-protec joint having a substantially annular shaped inner region, wherein said substantially annular shaped inner region h as a plurality of raised semispheroidal members;
coupling said fiber reinforced composite upper portion to said I-protec joint;
coupling said fiber reinforced composite upper portion to a steering wheel;
coupling said fiber reinforced composite bottom portion to said I-protec joint; and
coupling said fiber reinforced composite bottom portion to a rack and pinion system.

19. The method of claim 18, wherein coupling said fiber reinforced composite bottom portion to said I-protec joint comprises coupling a corresponding race of said fiber reinforced composite bottom portion within a plurality of raised semispheroidal members of said I-protec joint.

20. The method of claim 19, wherein coupling said fiber reinforced composite upper portion to said I-protec joint comprises press fitting a lower shoulder of said fiber reinforced composite upper portion to a corresponding portion of said I-protec joint.
